(19) United States
(12) Patent Application Publication
(10) Pub. No.: US 2012/0184116 A1
(43) Pub. Date: Jul. 19, 2012

(54) INTERPOSER

(75) Inventors: Gregory Thomas PAWLIKOWSKI, Windsor, PA (US); George Jyh-Shann CHOU, Mechanicsburg, PA (US)

(73) Assignee: TYCO ELECTRONICS CORPORATION, BERWYN, PA (US)

(21) Appl. No.: 13/008,625

(22) Filed: Jan. 18, 2011

(51) Int. Cl. H01R 12/52

(52) U.S. Cl. 439/66

(57) ABSTRACT

An interposer includes a substrate having a first surface and a second surface with vias extending between the first and second surfaces. The interposer also includes a contact array mounted to the first surface that has a plurality of coil-shaped contacts. The contacts have heels terminated to corresponding vias. The contacts have beams defining a mating interface of the interposer configured for mating with an electronic component. The contacts may be conic helix shaped. The beams may include at least one turn. The beams may be free standing from the heel and may be compressible along contact axes toward the first surface of the substrate.

### BACKGROUND OF THE INVENTION

The subject matter herein relates generally to interposers used to connect electronic components.

Various packages or devices exist within the computer industry which require interconnection to a printed circuit board. The devices have lands or balls which are placed on predetermined centerline spacing or pitch, such as 1.0 mm and below. The devices are profiled with arrays of 50 by 50 and even greater. Given the plurality of lands, their centerline spacing, and given the force applied to each land, the devices cause a variety of problems in practice in connection to the printed circuit board.

Sockets exist within the market for the interconnection of such devices, where the sockets include a substrate having contacts terminated to one side of the substrate for connection to the package or device and contacts or balls terminated to the other side of the substrate for connection to the printed circuit board. The contacts have pitches that correspond with the spacing of lands or balls on the device. Attachment of the contacts to the substrate, particularly when the centerline spacing is small, is difficult and time consuming. As the size of contacts decrease to accommodate finer pitches in high density arrays, the amount of material in the contact may not be great enough to support the mechanical requirements, such as normal force and working range of the system. This is especially problematic in contacts formed on pitch out of the available material in the array, as the available material is limited by the space between pitch centers. Traditional methods of contact construction utilize enough material necessary to meet the mechanical and/or electrical requirements of the contact, and then form the material into a shape that will fit within the allowable space within the array. This is commonly done using a bent beam design that often contains features that overlap neighboring contact areas of the array, but don't interfere with their electrical connectivity. When forming the contacts on pitch, only the material in each isolated contact area is available for forming the contact's shape. As pitches in arrays become smaller, the space limitations prevent the use of traditional bent beam designs.

A need remains for an interposer that may be manufactured in a cost effective and reliable manner. A need remains for a mechanically and electrically effective contact for use in an interposer having high density that may be formed on pitch in a cost effective manner.

### BRIEF DESCRIPTION OF THE INVENTION

In one embodiment, an interposer is provided having a substrate having a first surface and a second surface with vias extending between the first and second surfaces. The interposer also includes a contact array mounted to the first surface that has a plurality of coil-shaped contacts. The contacts have heels terminated to corresponding vias. The contacts have beams defining a mating interface of the interposer configured for mating with an electronic component. Optionally, the contacts may be conic helix shaped. The beams may include at least one turn. The beams may be free standing from the heel and may be compressible along contact axes toward the first surface of the substrate.

In another embodiment, an interposer is provided having a thin, flexible substrate having a first surface and a second surface with a thin metal spacer between the first and second surfaces. The interposer also includes a contact array mounted to the first surface that has a plurality of coil-shaped contacts. The contacts have heels terminated to corresponding metal spacer. The contacts have beams defining a mating interface of the interposer configured for mating with an electronic component. Optionally, the contacts may be conic helix shaped. The beams may include at least one turn. The beams may be free standing from the heel and may be compressible along contact axes toward the first surface of the substrate.

In another embodiment, a contact array is provided for an interposer having a substrate. The contact array has a film and a plurality of contacts held by the film. The contacts have heels configured to be terminated to the substrate and beams extending from the heels. The beams are coil-shaped and have pads defining a mating interface of the interposer configured for mating with an electronic component.

In a further embodiment, an interposer is provided having a substrate having a first surface and a second surface with conductors extending between the first and second surfaces. An array of solder balls are soldered to the second surface and are electrically connected to corresponding conductors. A contact array is mounted to the first surface that has a plurality of coil-shaped contacts. The contacts have heels terminated to the first surface and are electrically connected to corresponding conductors. The contacts having coil-shaped beams define a mating interface of the interposer that is configured for mating with an electronic component.

In a further embodiment, an interposer is provided having a substrate having a first surface and a second surface with conductors extending between the first and second surfaces. A first contact array having a plurality of coil-shaped contacts is mounted to the first surface and is electrically connected to corresponding conductors. A second contact array having a plurality of coil-shaped contacts is mounted to the second surface and is electrically connected to corresponding conductors. The contacts having coil-shaped beams define a mating interface of the interposer configured for mating with first and second electronic components.

### BRIEF DESCRIPTION OF THE DRAWINGS

FIG. 1 is top perspective view of an interposer formed in accordance with an exemplary embodiment.

FIG. 2 is a top view of a contact used with the interposer.

FIG. 3 is a side view of the contact shown in FIG. 2.

FIG. 4 is a cross-sectional view of a portion of the interposer.

FIG. 5 is a top view of a portion of a contact array for the interposer.

FIG. 6 is a top view of an alternative contact used with the interposer.

FIG. 7 is a side view of the contact shown in FIG. 6.

### DETAILED DESCRIPTION OF THE INVENTION

The subject matter herein relates to interposers, such as a land grid array (LGA) interposer. The interposer is configured to be used to connect two electronic components. For example, the interposer may be used as a chip interconnect for connecting a chip to a printed circuit board. However, it could also mean a board-to-board interconnect. In the illustrated embodiments herein, the subject matter will be described by way of an interconnect to a chip.

FIG. 1 is top perspective view of an interposer 100 formed in accordance with an exemplary embodiment. The interposer 100 includes a substrate 102 and a housing 104 including guide walls 106. The guide walls 106 define an inner chip receiving nest 108 that is configured to receive an electronic component (not shown), such as a chip or processor. The interposer 100 defines a socket for receiving the electronic component. A contact array 110 is provided on the substrate 102 that defines a separable interface for interfacing with the electronic component received within the nest 108.

The contact array 110 includes a plurality of individual contacts 112, only a portion of which are shown in FIG. 1. Optionally, the entire nest 108 may be filled with contacts 112 arranged in a predetermined pattern that corresponds with a pattern of lands or balls on the electronic component. Any number of contacts 112 may be provided. In the illustrated embodiment, the contacts 112 are arranged in a grid of approximately 50 contacts by 50 contacts. The contacts 112 may be arranged at a predetermined pitch, such as a pitch of approximately 1.0 mm or less. A portion of the contact array 110 is enlarged to show a more detailed view of the contacts 112.

The substrate 102 extends between a first side 120 and a second side 122. The contact array 110 is provided along the first side 120. In the illustrated embodiment, the housing 104 is mounted to the first side 120. Alternatively, the housing 104 may surround the substrate 102 such that the substrate 102 is received within the housing 104. The second side 122 is configured to be mounted to another component, such as a printed circuit board (not shown). The second side 122 may be soldered to the printed circuit board using an array of solder balls. Other attachment means are possible in alternative embodiments. In some alternative embodiments, a second contact array may be attached to the second side 120.

The interposer 100 includes a coverlay 126 that is applied over the contact array 110. The coverlay 126 includes openings 128 that fit around the contacts 112 when the coverlay 126 is coupled to the first side 120 of the substrate 102. The coverlay 126 defines a spacer for the contacts 112 so that the contacts 112 do not bottom out against the substrate 102 when the electronic component is coupled to the interposer 100.

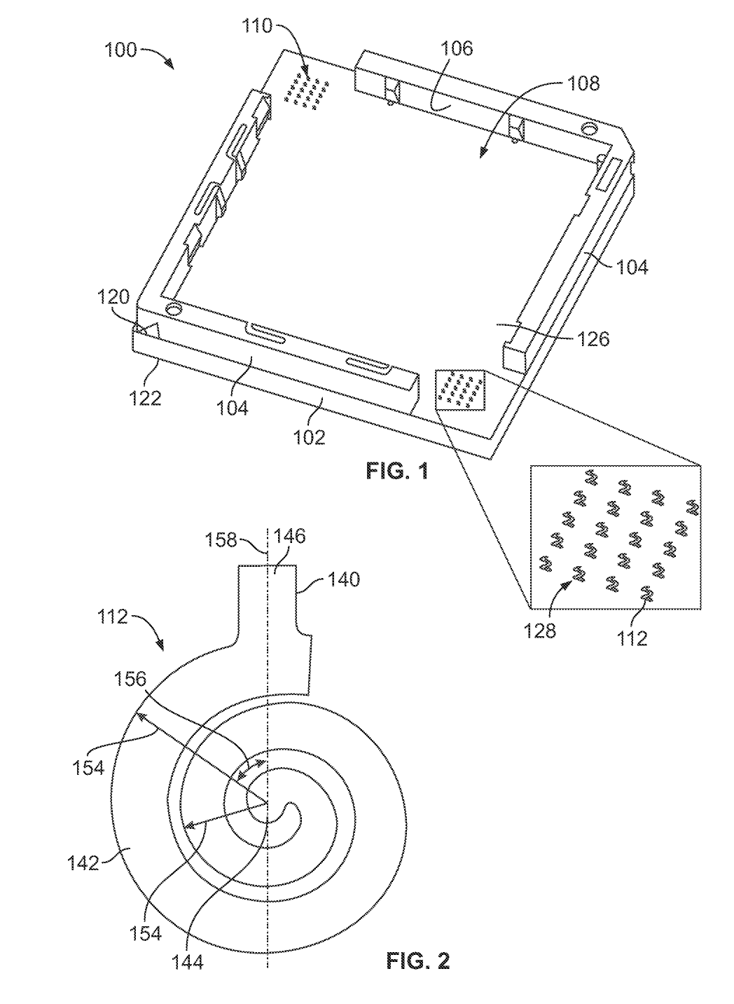

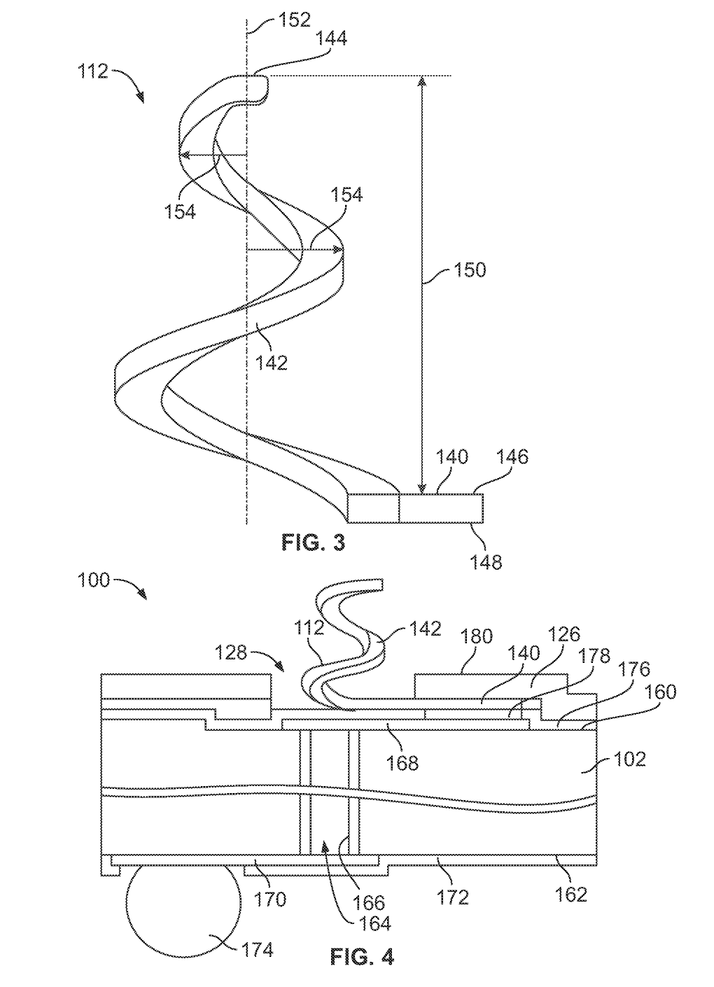

FIGS. 2 and 3 are top and side views, respectively, of one of the contacts 112. The contact 112 includes a contact heel 140 and a beam 142 extending from the contact heel 140. In an exemplary embodiment, the beam 142 has a coiled shape defining a spring. The beam 142 is free-standing (e.g. self-supporting) and is configured to be compressed when mated with the electronic component. The beam 142 extends to a tip and a pad 144 is provided at the tip for mating to the electronic component. The pad 144 defines a separable mating interface for interfacing with the electronic component received in the interposer 100 (shown in FIG. 1).

The contact heel 140 has an upper surface 146 and a lower surface 148. The upper and lower surfaces 146, 148 are planar and parallel to one another. The lower surface 148 defines a mounting surface for mounting the contact 112 to the substrate 102. In an exemplary embodiment, the lower surface 148 is configured to be soldered to the substrate 102.

In an exemplary embodiment, the beam 142 is a conic helix shaped spring beam. The beam 142 extends a height 150 along a contact axis 152. The beam 142 is coiled around the contact axis 152. The beam 142 is a three-dimensional curve with a continuously varying distance from the axis 152. The beam 142 may have a shape of a logarithmic spiral, an Archimedean spiral, or another spiral shape. The beam 142 may have a constant radius of curvature or a changing radius of curvature. The beam 142 may have any arc length and/or radius of curvature. Optionally, both a radius 154 of the beam 142 and the height 150 of the beam 142 are a continuous monotonic function of an angle 156 from a longitudinal axis 158 of the contact 112. The contact heel 140 extends along the longitudinal axis 158. Optionally, the contact 112 is widest along the longitudinal axis 158.

In an exemplary embodiment, the beam 142 has more than one turn (e.g. extends more than 360°). In the illustrated embodiment, the beam 142 has approximately 2 turns. The beam 142 may have more or less turns in alternative embodiments. In the illustrated embodiment, the contact heel 140 is provided at a radially outer portion of the contact 112 and the pad 144 is provided at a radially inner portion of the contact 112, such that the diameter of the contact 112 increases with the height 150 from the substrate 102 (shown in FIG. 1). In an alternative embodiment, the contact heel 140 is provided at a radially inner portion of the contact 112 and the pad 144 is provided at a radially outer portion of the contact 112, such that the diameter of the contact 112 decreases with the height 150 from the substrate 102 (shown in FIG. 1).

In an exemplary embodiment, the contact 112 is manufactured from a conductive material, such as copper or a copper alloy. The contact 112 may be manufactured by forming the beam 142 in a spiral shape from a metal workpiece and then deforming the beam 142 by lengthening the beam 142 along the contact axis 152. For example, the beam 142 may be formed by an etching process, such as a chemical etching process. Alternatively, the beam 142 may be formed by another process, such as a stamping process. The beam 142 may be deformed by pressing or pulling the contact 140 and/or the pad 144 to lengthen the beam 142 along the contact axis 152 (e.g. in the height 150 direction). Portions of the contact 112 may be plated. For example, the pad 144 may be nickel plated. Optionally, the lower surface 148 of the heel 140 may not be plated, but rather may include an organic solderability preservative (OSP) coating.

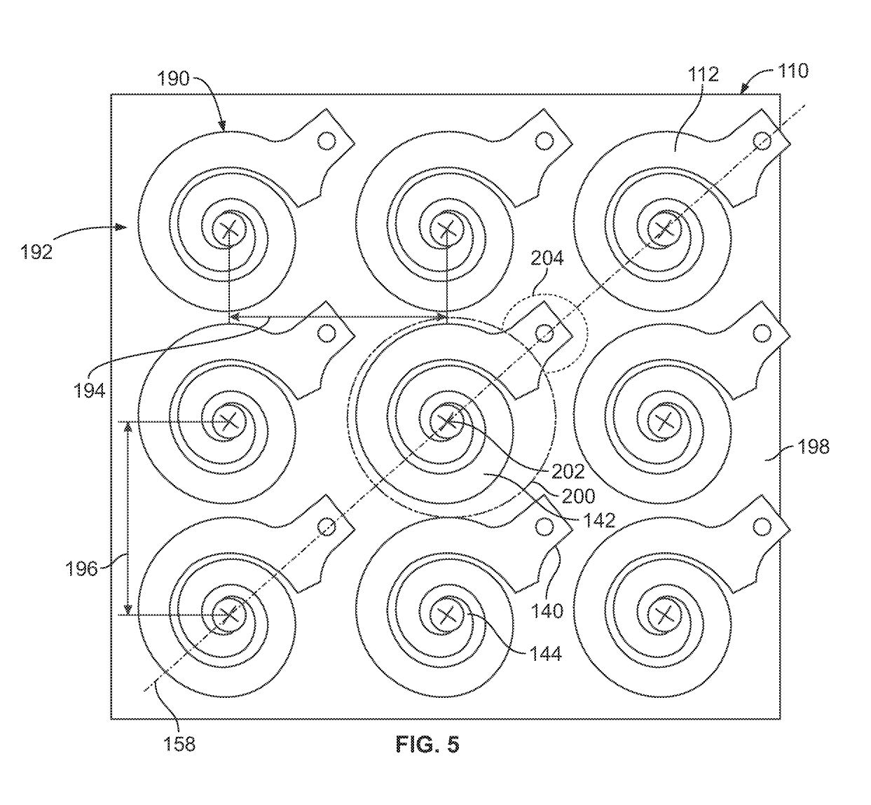

FIG. 4 is a cross-sectional view of a portion of the interposer 100. The substrate 102 has a first surface 160 and a second surface 162 opposite to the first surface 160. A plurality of conductors 164 (only one of which is shown in FIG. 4) extend through the substrate 102. In the illustrated embodiment, the conductors 164 are defined by plated vias extending through the substrate 102 with a plating layer 166 between the first and second surfaces 160, 162. Alternatively, rather than being a plated via, the conductor 164 may be a filled via that is filled with a conductive material, such as a conductive epoxy, or the conductor 164 may be a contact or other conductive element extending between the first and second surfaces 160, 162. A first pad 168 is provided along the first surface 160. A second pad 170 is provided along the second surface 162. The conductor 164 electrically connects the first and second pads 168, 170. Optionally, the conductor 164 and the pads 168, 170 may be integrally formed.

A solder mask 172 is provided over the second surface 162 and/or a portion of the second pad 170. A solder ball 174 is soldered to the second pad 170. In alternative embodiments, rather than attaching solder balls 174 to the second surface 162, another contact array may be provided on the second surface 162.

A solder mask 176 is provided over the first surface 160 and/or a portion of the first pad 168. Solder 178 is provided between the first pad 168 and the contact 112 to electrically connect the contact 112 to the first pad 168. The contact heel 140 is soldered to the first pad 168 using the solder 178. The contact heel 140 may be attached by other means, such as welding, using conductive epoxy and the like. In other alternative embodiments, rather than mechanically securing the contact heel 140 to the first pad 168, the contact heel 140 may be held in direct physical contact with the first pad 168, such as using a carrier film, where the contacts 112 are laminated to the carrier film and the carrier film is attached to the first surface 160 using adhesive or another securing means. The carrier film holds a plurality of the contacts 112 as a unit such that all of the contacts 112 may be simultaneously mounted to the substrate 102. The compression of the contacts 112 holds the contact heels 140 in engagement with the first pads 168.

The beam 142 extends from the contact heel 140 away from the first surface 160. The beam 142 is deflectable and may be deflected toward the substrate 102 when the electronic component is attached to the interposer 100. The coverlay 126 extends over the substrate 102 and may cover a portion of the contact 112, such as the contact heel 140. The opening 128 is aligned with the beam 142 such that the contact 112 may extend through the coverlay 126. As the electronic component is loaded into the interposer 100, the electronic component engages an outer surface 180 of the coverlay 126 to define a stop for the electronic component. When the electronic component engages the outer surface 180, the beam 142 is positioned within the opening 128 and is in a compressed state.

FIG. 5 is a top view of a portion of the contact array 110. The contacts 112 are arranged in columns 190 and rows 192. The contacts 112 are arranged at a predetermined column pitch 194 and a predetermined row pitch 196. Optionally, the column and row pitches 194, 196 may be the same. Alternatively, the column and row pitches 194, 196 may be different. In another alternative embodiment, the contact array 110 may be arranged in a hexagonal pattern with the columns of adjacent rows shifted by one half the pitch distance in a direction parallel to the rows. Other configurations of the contacts 112 are possible in other alternative embodiments depending on the particular application and the arrangement of contacts or pads on the electronic component(s).

The contact array 110 includes a carrier film 198 that holds the contacts 112. The carrier film 198 may be laminated to the metal workpiece used to form the contacts 112. Portions of the carrier film 198 may be removed during manufacture, while other portions of the carrier film 198 remain holding the contacts 112 together such that the contact array 110 may be attached to the substrate 102 (shown in FIG. 1).

The beams 142 are formed from the material available within a radial area 200 surrounding a central point 202. Optionally, the contact axis 150 (shown in FIG. 3) is coincident with the central point 202. The pad 144 may be provided at the central point 202. The radial area 200 surrounds the central point 202. The metal of the workpiece outside of the radial area 200 is removed, thus separating the contacts 112 from one another. Portions of the metal of the workpiece inside the radial area 200 are removed, thus defining the spiral shape of the contact 112. Alternatively, the coil beams are formed by shearing portions of the metal of the workpiece inside the radial area 200 without removing material.

In the illustrated embodiment, the longitudinal axes 158 are oriented transverse to the columns 190 and rows 192. Optionally, the longitudinal axes 158 are oriented approximately 45° to the columns 190 and the rows 192. The contact heels 140 extend along the longitudinal axes 158. The contact array 110 has tangential areas 204 off to one side of corresponding radial areas 200. The contact heels 140 are formed in the tangential areas 204. The longitudinal axes 158 extend through the tangential areas 204. The tangential areas 204 are provided between radial areas 200 of adjacent contacts 112. For example, because the radial areas 200 are generally circular in shape, “dead zones” are defined between four adjacent contacts 112. The tangential areas 204 extend into corresponding dead zones. By maximizing the size of the radial areas 200 and utilizing the tangential areas 204 between the radial areas 200, usage of the metal material of the workpiece is optimized between the pitch centers. By making the beams 142 as thick as practical, the amount of metal material of the workpiece used for mechanical and electrical integrity is optimized giving the contacts 112 good mechanical strength to withstand the compression and to allow the contacts 112 to impart a normal force on the electrical component to maintain electrical contact therewith.

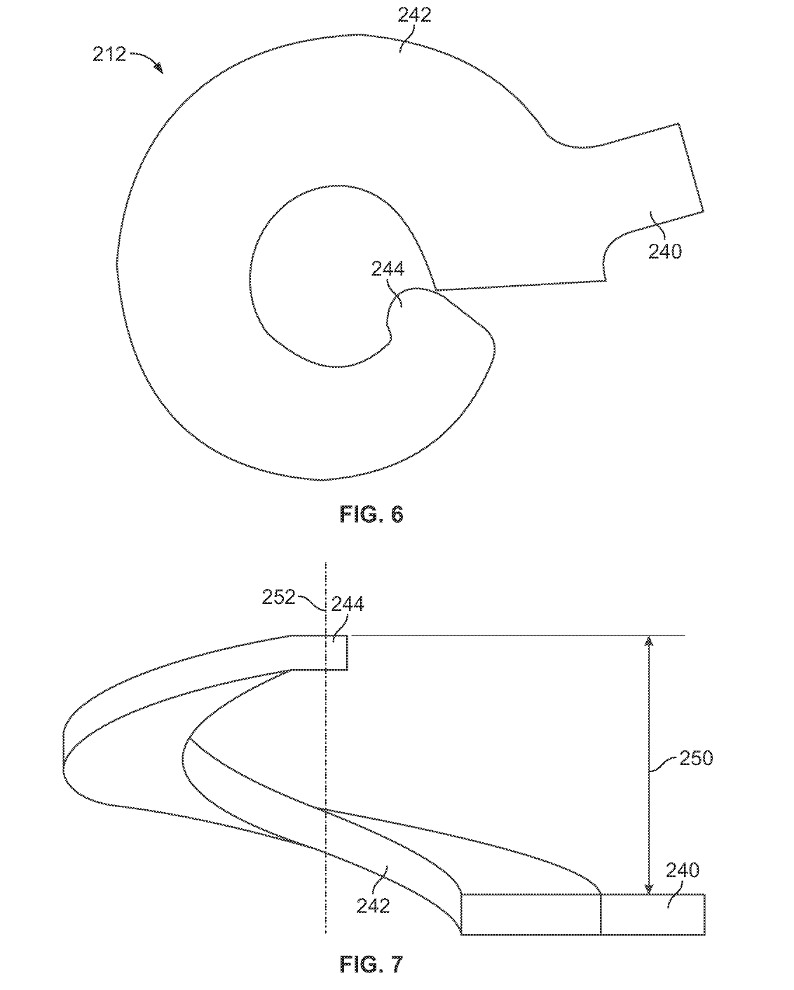

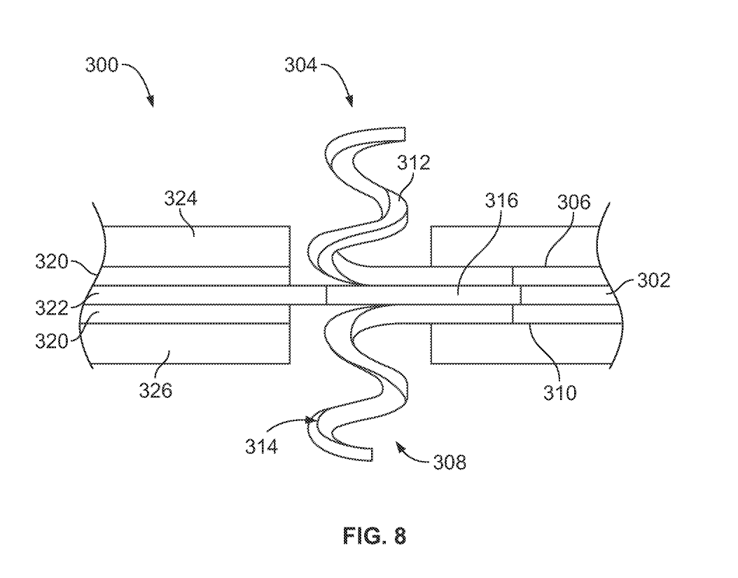

FIGS. 6 and 7 are top and side views, respectively, of an alternative contact 212. The contact 212 includes a contact heel 240 and a beam 242 extending from the contact heel 240. In an exemplary embodiment, the beam 242 has a coiled shape defining a spring. The beam 242 is free-standing (e.g. self-supporting) and is configured to be compressed when mated with the electronic component. The beam 242 extends to a tip and a pad 244 is provided at the tip for mating to the electronic component. The pad 244 defines a separable mating interface for interfacing with an electronic component.

In an exemplary embodiment, the beam 242 is a conic helix shaped spring beam. The beam 242 extends a height 250 along a contact axis 252. The beam 242 is coiled around the contact axis 252. The beam 242 is a three-dimensional curve with a continuously varying distance from the axis 252. The beam 242 may have a shape of a logarithmic spiral, an Archimedean spiral, or another spiral shape. In the illustrated embodiment, the beam 242 has a constant radius of curvature.

In an exemplary embodiment, the beam 242 has less than one turn (e.g. extends less than 360°). The beam 242 is generally thicker than the beam 142 (shown in FIGS. 2 and 3), which may increase the mechanical properties of the contacts 212, however, less material is available for lengthening, and thus the beam 242 is shorter as compared to the beam 142.

FIG. 8 is a cross sectional view of an alternative interposer 300 that uses a flexible film substrate 302. A first contact array 304 is provided on a first surface 306 of the substrate 302 and a second contact array 308 is provided on a second surface 310 of the substrate 302. The first and second contact arrays 304, 308 define separable interfaces for interfacing with first and second electronic components, such as circuit boards, chips, processors, and the like.

The first contact array 304 includes a plurality of individual coil-shaped contacts 312, which may be the same as or similar to the contacts 112 (shown in FIGS. 1-5). The second contact array 308 includes a plurality of individual coil-shaped contacts 314, which may be the same as or similar to the contacts 112. Contacts 312 of the first contact array 304 are electrically connected to corresponding contacts 314 of the second contact array 308 by conductors 316 of the substrate 302.

The substrate 302 includes conductive and non-conductive films or layers 320, 322 that are laminated together. Optionally, the contacts 312, 314 may be formed from corresponding conductive layers 320, such as by etching or otherwise removing portions of the conductive layers 320. The contacts 312, 314 are formed on pitch with material available in radial areas of the conductive layers 320 defined between pitch centers. The substrate 302 includes metal spacers that define the conductors 316 through the substrate 302. The conductors 316 extend through the non-conductive layer(s) 322. Optionally, coverlays 324, 326 may be provided on the outer layers of the substrate 302. The contacts 312, 314 extend through the coverlays 324, 326, respectively.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. An interposer comprising:
a substrate having a first surface and a second surface, the substrate having conductors extending between the first and second surfaces; and
a contact array mounted to the first surface, the contact array comprising a plurality of coil-shaped contacts, the contacts having heels terminated to corresponding conductors of the substrate, the contacts having beams defining a mating interface of the interposer configured for mating with an electronic component.

2. The interposer of claim 1, wherein the contacts are conic helix shaped.

3. The interposer of claim 1, wherein the beams include at least one turn.

4. The interposer of claim 1, wherein the beams have pads at tips of the beams, the pads being elevated a height above the first surface, the beams being compressible such that the height is reduced when mated with the electronic component.

5. The interposer of claim 1, wherein the contact array includes a film, the contacts being held together by the film and applied to the substrate with the film.

6. The interposer of claim 1, wherein the contacts are manufactured by forming the beams in a spiral shape from a metal workpiece and deforming the beams by lengthening the beams along contact axes.

7. The interposer of claim 1, wherein the beams are free standing from the heel and compressible along contact axes toward the first surface.

8. The interposer of claim 1, wherein the contacts have a height measured from the first surface along contact axes, the beams extending along a 3-D curve with a continuously varying distance from the corresponding contact axes.

9. The interposer of claim 1, wherein the contacts are formed on pitch with material available in radial areas defined between pitch centers.

10. The interposer of claim 1, further comprising a second contact array mounted to the second surface, the second contact array comprising a plurality of coil-shaped contacts configured for mating with a second electronic component.

11. The interposer of claim 1, further comprising an array of solder balls soldered to the second surface and electrically connected to corresponding conductors of the substrate.

12. The interposer of claim 1, wherein the contacts extend along contact axes, each beam having a radius and a height that are continuous monotonic functions of an angle of the beam measured from the heel.

13. The interposer of claim 1, wherein the substrate comprises a thin flexible substrate constructed by laminating conductive and non-conductive films, with the conductors being defined by metal spacers.

14. A contact array for an interposer having a substrate, the contact array comprising:
a film; and
a plurality of contacts held by the film, the contacts having heels configured to be terminated to the substrate, the contacts having beams extending from the heels, the beams being coil-shaped and having pads defining a mating interface of the interposer configured for mating with an electronic component.

15. The contact array of claim 14, wherein the beams are conic helix shaped.

16. The contact array of claim 14, wherein the beams include at least one turn.

17. The contact array of claim 14, wherein the pads are elevated a height above the substrate, the beams being compressible such that the height is reduced when mated with the electronic component.

18. The contact array of claim 14, wherein the film is configured to be applied to the substrate to position the plurality of contacts on the substrate.

19. The contact array of claim 14, wherein the contacts are manufactured by forming the beams in a spiral shape from a metal workpiece and deforming the beams by lengthening the beams along contact axes.

20. The contact array of claim 14, wherein the beams are free standing from the heel and compressible along contact axes toward the first surface.

21. The contact array of claim 14, wherein the contacts have a height measured from the substrate along contact axes, the beams extending along a 3-D curve with a continuously varying distance from the corresponding contact axes.

22. The contact array of claim 14, wherein the contacts are formed on pitch with material available in radial areas defined between pitch centers.

23. An interposer comprising:
a substrate having a first surface and a second surface, the substrate having conductors extending between the first and second surfaces;
a first contact array mounted to the first surface, the first contact array comprising a plurality of coil-shaped contacts, the contacts having heels terminated to the first surface and being electrically connected to corresponding conductors of the substrate, the contacts having coil-shaped beams defining a mating interface of the interposer configured for mating with a first electronic component; and
a second contact array mounted to the second surface, the second contact array comprising a plurality of coil-shaped contacts, the contacts of the second contact array having heels terminated to the second surface and being electrically connected to corresponding conductors of the substrate, the contacts of the second contact array having coil-shaped beams defining a mating interface of the interposer configured for mating with a second electronic component.

24. The interposer of claim 23, wherein the contacts are conic helix shaped.

25. The interposer of claim 23, wherein the substrate comprises a thin flexible substrate constructed by laminating conductive and non-conductive films, with the conductors being defined by metal spacers.
